(19) United States
(12) Patent Application Publication
(10) Pub. No.: US 2024/0028606 A1
(43) Pub. Date: Jan. 25, 2024

(54) DATA CATALOG AND RETRIEVAL SYSTEM

(71) Applicant: Calabrio Inc., Minneapolis, MN (US)

(72) Inventors: Boris Chaplin, Medina, MN (US); Chris Vanciu, Isle, MN (US); Kyle Smaagard, Forest Lake, MN (US); Dylan Morgan, Minneapolis, MN (US); Catherine Bullock, Minneapolis, MN (US); Laura Cattaneo, Rochester, MN (US); Matt Matsui, Minneapolis, MN (US)

(21) Appl. No.: 18/358,619

(22) Filed: Jul. 25, 2023

Related U.S. Application Data
(60) Provisional application No. 63/369,360, filed on Jul. 25, 2022.

(51) Int. Cl. G06F 16/25; G06F 16/14

(52) U.S. Cl. CPC G06F 16/258; G06F 16/148; G06F 16/164

(57) ABSTRACT

Systems and methods are provided for cataloging and retrieving data. The systems access data stored at a data storage and determine its data type. When a data type is unknown to the systems, the systems generate configuration data for data ingress and validate the data in a test environment. Once the data ingress succeeds in the testing environment, the systems transform data format to a known format, itemize parts of data for cataloging, extract the parts of data, and generates metadata associated with the data. The systems store both the metadata and the extracted data a final data store. A local data server with a web server includes a database of metadata for locally determining locations of data needed to generate a response to a data query. Metadata includes labels associated with itemized data stored in the final data store.

### BACKGROUND

As use of artificial intelligence based on machine learning models becomes commonplace, training the machine learning models become important. There has been a need to the systems to improve efficiencies in both acquiring data (e.g., data ingress) from remote data storages and cataloguing the data. In addition to acquiring data, the systems need to catalog content of the data for responding to queries that search parts of the data in a timely manner.

It is with respect to these and other general considerations that the aspects disclosed herein have been made. Although relatively specific problems may be discussed, it should be understood that the examples should not be limited to solving the specific problems identified in the background or elsewhere in this disclosure.

### SUMMARY

Aspects of the present disclosure relate to acquiring, cataloging, and retrieving data. For example, the present disclosure ingresses a set of data with a known data type, identifies and stores metadata for file(s) and items within the file(s) and then stores the data set. The stored metadata may then be searched and used to locate and retrieve items matching the search criteria. Cataloging the set of data includes transforming known data to a standard format, itemizing (identifying specific items within one or more files) to obtain metadata for an item, and storing the metadata for one or more items so that it may be searched later. Once metadata and files in the dataset are stored, they may be searched to identify individual items that may be extracted. The search generates a configuration file that is used to extract the individual items. The extraction process uses the configuration file to extract items to produce an isolated dataset, conforming to the search criteria.

This Summary introduces a selection of concepts in a simplified form, which is further described below in the Detailed Description. This Summary is not intended to identify key features or essential features of the claimed subject matter, nor is it intended to be used to limit the scope of the claimed subject matter. Additional aspects, features, and/or advantages of examples will be set forth in part in the following description and, in part, will be apparent from the description, or may be learned by practice of the disclosure.

### BRIEF DESCRIPTIONS OF THE DRAWINGS

Non-limiting and non-exhaustive examples are described with reference to the following figures.

FIG. 1 illustrates an overview of an example system for data cataloging and ingress in accordance with aspects of the present disclosure.

FIG. 2 illustrates an exemplary system for cataloging and retrieving data in accordance with aspects of the present disclosure.

FIG. 3 illustrates an example of extraction configuration data in accordance with aspects of the present disclosure.

FIG. 4 illustrates an example of data ingress and egress scripts in accordance with aspects of the present disclosure.

FIGS. 5A-B illustrate exemplary extraction configuration data and metadata in accordance with aspects of the present disclosure.

FIG. 6A illustrates an example method for performing data ingress in accordance with aspects of the present disclosure.

FIG. 6B illustrates an example method for data egress in accordance with aspects of the present disclosure.

FIG. 7 illustrates a simplified block diagram of a device with which aspects of the present disclosure may be practiced in accordance with aspects of the present disclosure.

### DETAILED DESCRIPTION

Various aspects of the disclosure are described more fully below with reference to the accompanying drawings, which from a part hereof, and which show specific example aspects. However, different aspects of the disclosure may be implemented in many different ways and should not be construed as limited to the aspects set forth herein; rather, these aspects are provided so that this disclosure will be thorough and complete, and will fully convey the scope of the aspects to those skilled in the art. Practicing aspects may be as methods, systems, or devices. Accordingly, aspects may take the form of a hardware implementation, an entirely software implementation or an implementation combining software and hardware aspects. The following detailed description is, therefore, not to be taken in a limiting sense.

Processing data analytics has become an important part for understanding the current state of matters and for planning ways to improve daily practices. The performance of machine learning models, e.g., the ability to make decisions and form predictions more accurately, increases as the machine learning models are trained using additional training data. Data catalog and retrieval systems become more useful at generating training data by receiving various queries, retrieving resulting sets of data in response to the various queries, and creating training data based on the resulting sets of data. The systems access and acquire data stored using various data types and at various locations across the network. The systems further itemize content of the data and extract the itemized parts of the data for cataloging. The systems receive queries for specific conditions for a search and responds with metadata and/or the itemized data.

Issues arise when either as the volume of data or the variation of types of data (e.g., data formats) increase. For example, customer support centers analyze recordings of incoming customer support calls (e.g., customer contacts) to understand and control the quality of interactions with calling customers. A data type may include, as an example, voice and/or audio data and transcript data, among other types of data. A variation of distinct transcription systems translates into an increase in a variation of data formats of transcript data.

In aspects, a data catalog and retrieval system acquire data (e.g., performing data ingress) from remote data repositories. The system catalogs the acquired data for the subsequent processing of queries, retrieval of data in response to the queries, and response to the queries. For example, transcript data for a voice conversation may be analyzed based on words and phrases that were spoken during the voice conversation, social media messages and posted data may be searched and analyzed, etc. In aspects, a query may request excerpts of conversations in both a voice recording data format, a transcript data format, or any other type of data format available. In further aspects, artificial intelligent development tools may query instances of utterances and automatically generate a set of training data to train the machine-learning model.

An issue may arise when the number of types of data and the size of the data become too large for local storage and/or too large to generate a response to search queries in a timely manner. To address issues related to maintaining accuracy and timeliness, the data catalog and retrieval system may automatically generate metadata corresponding to the data and use the metadata to process and respond to queries. The metadata may include attribute data and indirect references to the data.

Another issue may arise when data types vary and, in some cases, are unknown to (or unidentifiable by) the data catalog and retrieval system. The disclosed technology maintains configuration data corresponding to a data type. The configuration data specify code instructions and parameters needed to successfully generate metadata based on the data and data type. In aspects, the present disclosure automates cataloging the data and generating metadata from the data when a data type of the data is known (e.g., a set of configuration data for the data type already exists in the system). When a data type is unknown, the disclosed technology generates a new set of configuration data that corresponds to the unknown data type.

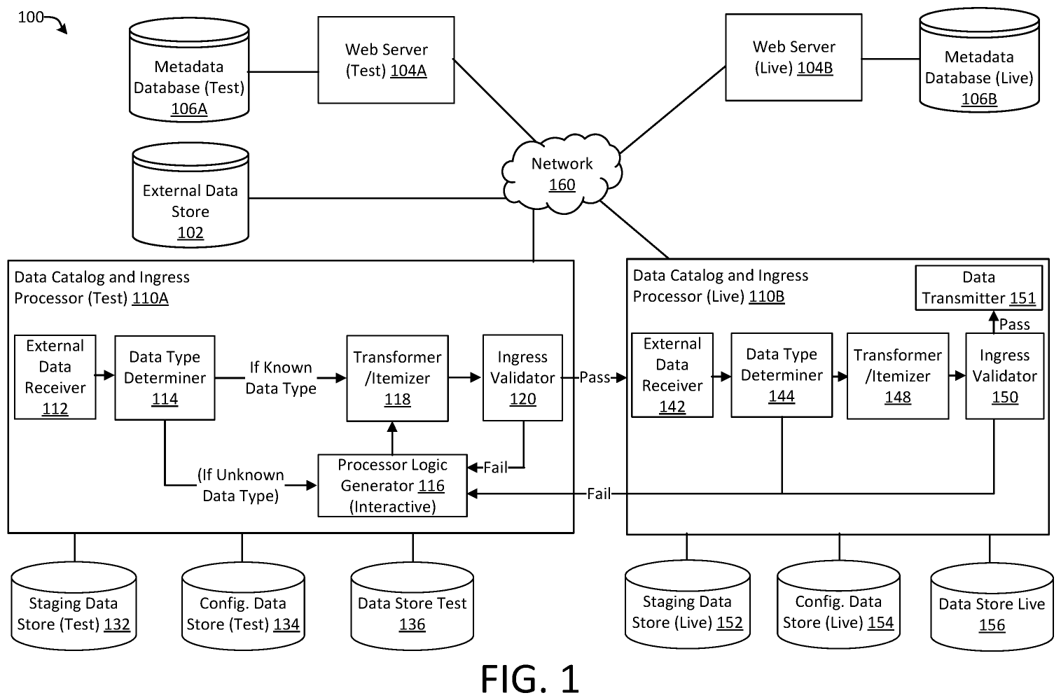

FIG. 1 illustrates an overview of an exemplary system for cataloging and transforming external data in accordance with aspects of the present disclosure. A system 100 may include an external data store 102, a web server (Test) 104A, a web server (Live) 104B, a metadata database (Test) 106A, a metadata database (Live) 106B, a data catalog and ingress processor (Test) 110A, a data catalog and ingress processor (Live) 110B, interconnected over a network 160. The data catalog and ingress processor (Test) 110A interactively generates processor logic for an ingress of external data of an unknown data type for testing ingress operations. Once the processor logic is generated and validated for the unknown data type to convert it to a known data type, the processor logic is installed in the data catalog and ingress processor (Live) 110B. The data catalog and ingress processor (Live) 110B performs data ingress of the data type in a live/production system environment.

The external data store 102 stores data for ingress operations. Data formats for respective audio/video data may vary. In aspects, the external data store 102 stores a set of raw data files including audio/video data and/or transcript data associated with a conversation and/or content and data associated with social media message exchanges. The set of raw data files may be termed “an acquisition set.” An acquisition set may fall under some specific conditions for data ingress, security requirements, time limits, and the like.

The data catalog and ingress processor (test) 110A may perform, in a test system environment, ingress of data stored in the external data store 102 by transferring data to a data store in a test system for subsequent testing of data ingress and cataloging the data for generating metadata of the data for retrieval. The data catalog and ingress processor (live) 110B may perform, in a live/production system environment, ingress of data store in the external data store 102 by transferring the data to a data store in a live system for subsequent data egress operations. The data catalog and ingress processor (live) 110B further generates metadata associated with the data for subsequent retrieval operations of the metadata. In aspects, the term “ingress” as used herein refers to copying of external data from an external data storage (e.g., a database, a data cloud, and the like) to a test or live data store through cataloging and transforming the external data into a combination data of a known data type and metadata associated with the data. In aspects, the term “egress” herein refers to retrieving the data of a known data type from the test or live data store for use.

The web server (test) 104A responds to a request by retrieving metadata that corresponds to the data being requested in the test system environment. In an example, the web server (test) 104A includes a metadata database (test) 106A. The metadata database (test) 106A includes searchable metadata associated with data that have completed ingress and catalogued in the test system environment. In another example, the web server (test) 104A may receive a request for data associated with particular metadata, causing an egress operation for outputting the data.

The data catalog and ingress processor (test) 110A performs ingress of data between the external data store 102 and the data store test 136, generating metadata to be stored in Metadata Database (test) 106A. The data catalog and ingress processor (test) 110A includes an external data receiver (test) 112, a data type determiner (test) 114, a processor logic generator (test) 116 (Interactive), a transformer/itemizer (test) 118, and an ingress validator (test) 120.

The external data receiver (test) 112 receives data from the external data store 102 over the network 160 and performs data ingress operations. In aspects, the external data receiver (test) 112 receives data from the external data store 102 and stores the data in the staging data store (test) 132. Storing the received external data in the staging data store (test) 132 reduces and/or eliminates needs to access the external data store 102 over the network 160 as the data catalog and ingress processor (test) 110A extracts and itemizes content of the data and generates metadata associated with the data.

The data type determiner (test) 114 determines a data type associated with the received data. The data type may include but not limited to: a data type of voice data (e.g., audio data), a data type of transcript data, content and/or information associated with postings on social media systems. For example, a data type for transcript data may include, but is not limited to, comma-separated values format, a document format, an XML format, etc. In aspects, the configuration data store (test) 134 stores configuration data (e.g., ingress driver configuration data) associated with data types that are known and/or registered with the data catalog and ingress processor (test) 110A. In some other aspects, the data type may include non-textual data (e.g., image data, voice data, video data, etc.) that are indexable and extractable for generating metadata associated with data.

When the data type determiner (test) 114 determines a data type of data as an unknown type (e.g., when the data type determiner 114 fails to identify the data type), the operation proceeds to the processor logic generator (test) 116 (Interactive). When the data type determiner (test) 114 determines a data type of the received data as a known type (e.g., the data type determiner (test) 114 identifies the data type), the operation proceeds to the transformer/itemizer (test) 118.

The processor logic generator (test) 116 (Interactive) interactively generates new configuration data that correspond to the data with the unknown data type. The processor logic generator (test) 116 interactively determines operations for extracting and itemizing content of the data for a local storage and generating metadata for subsequent retrievals. The processor logic generator (test) 116 generates configuration data associated with the data type. In aspects, the configuration data specifies instruction codes for successfully performing ingress and/or acquisition of the data from the external data store 102. For example, the instruction code may perform transformations of a data format, itemizations of at least a part of the content of the data, extraction of the content of the data, and testing of the integrity of the ingress operation. In some aspects, the processor logic generator (test) 116 may interactively receive new sets of instruction codes for processing content of the data with specific data types. After the processor logic generator (test) 116 generates the new configuration data, the operation proceeds to the transformer itemizer 118.

The transformer/itemizer (test) 118 transforms the data under the ingress operation and itemizes content of the data for indexing and for subsequent data egress operations in the test system environment, storing the metadata into metadata database 106A. The transformer/itemizer (test) 118 further generates metadata associated with the data for subsequent metadata retrieval operations in the test system environment.

The ingress validator (test) 120 validates ingress of data. In aspects, the ingress validator (test) 120 validates integrity of the catalogued data and metadata associated with data that has been processed under data ingress operations for testing. In aspects, the ingress validator (test) 120 tests data egress operations that retrieves the data from the data store test 136 using egress scripts (test).

When ingress validator (test) 120 results in a failure, the operation proceeds to the processor logic generator (test) 116 (Interactive) to interactively generate (and/or revise) the configuration data to correct validation failures. The ingress validator (test) 120 may retest using the configuration data after the processor logic generator (test) 116 (Interactive) re-generates the configuration data for the unknown data type for testing.

When the ingress validator 120 (test) results in a pass (e.g., a success) in the data ingress operations under the test system environment, the operation may proceed to the data catalog and ingress processor (live) 110B, which uses processing logics for data ingress operations for subsequent data egress operations and metadata retrieval operations.

The data catalog and ingress processor (live) 110B performs ingress (e.g., acquisition) of data of known data types using configuration data associated with the known data types. The data catalog and ingress processor (live) 110B receives data from the external data store 102 for data ingress operations in a live/production system environment. In aspects, the data includes a plurality of files. In aspects, the data catalog and ingress processor (live) 110B uses instruction code as specified by the configuration data stored in the configuration data store (live) 154 and transform files into a final storage format for cataloging. For example, data may be cleaned, sanitized (e.g., data being stripped of sensitive information), and re-formatted. The data catalog and ingress processor (live) 110B may use instruction code as specified by the configuration data to itemize content of files and generate metadata associated with the files and types of items in content of the file and/or the data.

The external data receiver (live) 142 receives data from the external data store 102 over the network 160 and performs data ingress operations in the live/production system environment. In aspects, the external data receiver (live) 142 receives data from the external data store 102 and stores in the staging data store (live) 152. Storing the received external data in the staging data store (live) 152 reduces and/or eliminates the need to access the external data store 102 over the network 160 as the data catalog and ingress processor (live) 110B extracts and itemizes content of the data and generates metadata associated with the data.

The data type determiner (live) 144 determines a data type associated with the received data. The data types may include, but not limited to, voice data (e.g., audio data), transcript data, content and/or information associated with postings on social media systems. For example, a data type for transcript data may include, but not limited to, comma-separated values format, document format, XML, etc. In aspects, the configuration data store (live) 154 stores configuration data (e.g., ingress driver configuration data) associated with data types that are known and/or registered with the data catalog and ingress processor (live) 110B. In some other aspects, the data type may include non-textual data (e.g., image data and voice data) that are indexable and extractable for generating metadata associated with data.

When the data type determiner (live) 144 fails to identify the data type, the process proceeds to the processor logic generator (test) 116 (Interactive) in the data catalog and ingress processor (test) 110A in the test system environment. When the data type determiner (live) 144 determines a data type of the received data as a known type (e.g., the data type determiner (live) 144 identifies the data type), the operation proceeds to the transformer/itemizer (live) 148.

The transformer/itemizer (live) 148 transforms the data under the ingress operation and itemizes content of the data for indexing and for subsequent data egress operations in the live/production system environment. The transformer/itemizer (live) 148 further generates metadata, storing the metadata in Metadata Database (Live) 106B associated with the data for subsequent metadata retrieval operations in the test system environment.

The ingress validator (live) 150 validates ingress of data in the live/production system environment. In aspects, the ingress validator (live) 150 validates integrity of the catalogued data and metadata associated with data that has been processed under data ingress operations.

When ingress validator (live) 150 results in a failure, the operation proceeds to the processor logic generator (test) 116 (Interactive) in the data catalog and ingress processor (test) 110A to interactively generate (and/or revises) the configuration data to correct the failure in validation. In aspects, the data catalog and ingress processor (live) ceases to perform data ingress operation of the data that failed the ingress validation until the configuration data (e.g., instruction scripts associated with data ingress and egress operations) are revised and pass the ingress validation by the ingress validator (test) 120 in the data catalog and ingress processor (test) 110A.

In aspects, items may include at least a part of a transcript, individual utterances, individual sentences, or other text segments. Selections of data for ingress may be based on an item type, length of item in time, or words, or sentences. Additional metadata may include a reference to transcription software. Additional metadata may be stored in the data store test 136, the data store live 156, and/or the metadata database 106.

The data store live 156 may store data for subsequent retrieval through data egress operations in response to queries. The metadata database (live) 106B may store the metadata associated with the data and may further include references to the data in the data store live 156.

The ingress validator (live) 150 validates data that has been processed by the data ingress operations in the live/production system environment. In aspects, external data having a known data type is stored at the external data store 102 may change into an unknown data type over time. For example, specifications of a transcription software for generating transcripts of conversations may change over time, thereby changing the underlying data format. In another example, data for ingress (e.g., an acquisition set) may include some unknown corruptions, and the like. When the ingress validator (live) 150 results in a pass (e.g., a success) in the data ingress operations under the test system environment, the operation may proceed to the data transmitter 151.

The data transmitter 151 may transmit metadata extracted from the data upon data ingress operations the metadata database (live) 106B over the network 160. In aspects, the web server (live) 104B may receive a request with a query to search for and retrieve metadata associated with data that has completed data ingress operations. In aspects, the disclosed technology provides a view of metadata and data associated with the metadata as data egress operations. In an example, a query may generate an extraction configuration file for retrieving a set of data associated with the data. In aspects, an extraction configuration file includes location information associated with items to be extracted from files associated with the data. An extraction configuration file may be reusable for regenerating retrieved data sets.

In aspects, interactive processing may take place at the web server (test) 104A and the web server (live) 104B with access to the metadata database (test) 106A and the metadata database (live) 106B respectively. Additionally, or alternatively, there may be multiple instances of the web server (test) 104A, the web server (live) 104B, the data catalog and ingress processor (test) 110A, and the data catalog and ingress processor (live) 110B for distributing processing of extracting scripts and extraction configuration files under a test system environment and a live/production system environment.

As will be appreciated, the various methods, devices, applications, features, etc., described with respect to FIG. 1 are not intended to limit the system 100 to being performed by the particular applications and features described. Accordingly, additional controller configurations may be used to practice the methods and systems herein and/or features and applications described may be excluded without departing from the methods and systems disclosed herein.

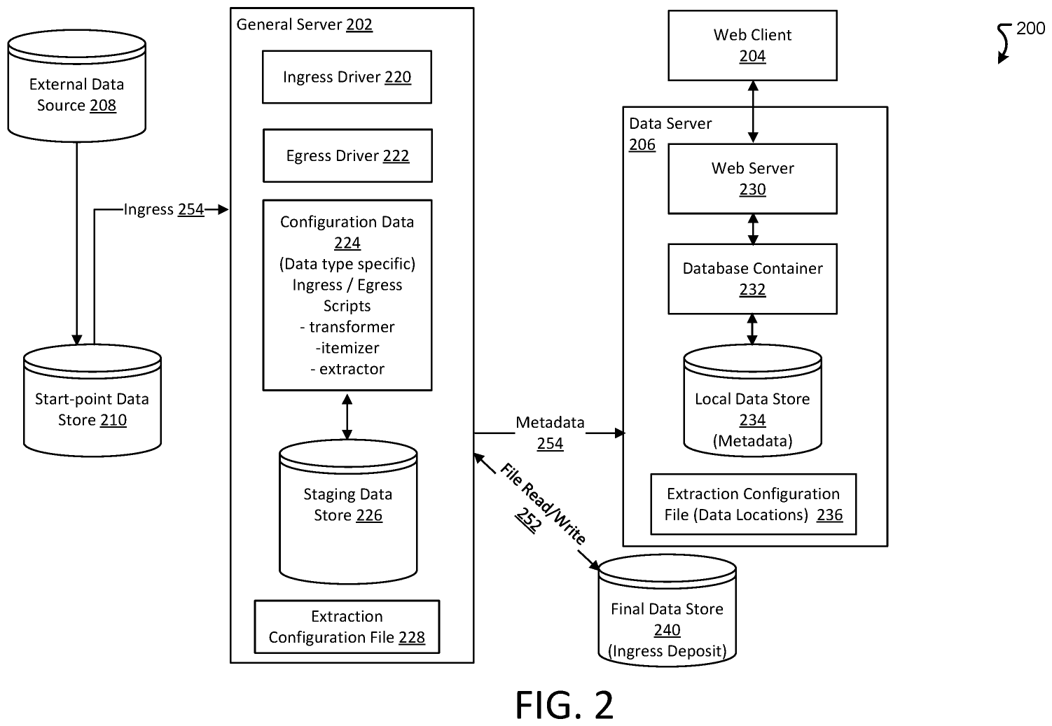

FIG. 2 illustrates an exemplary system for ingress/egress operations in accordance with aspects of the present disclosure. The system 200 includes a general server 202, a web client 204, a data server 206, an external data source 208, a starting-point data store 210, and a final data store 240. The general server 202 performs ingress (acquisition) and egress of data. The web client 204 provides an interactive user interface to user (e.g., an operator) to query and view metadata and content of the data. The web client 204 communicates with a data server 206. The data server 206 includes a web server 230 (e.g., the web server 104 as shown in FIG. 1), a database container 232, a local data store 234 (e.g., the metadata database 106 as shown in FIG. 1), and an extraction configuration file 236. In some aspects, the extraction configuration file 236 may be dynamically generated. In aspects, the general server 202 (e.g., Ingress server) sends “metadata” to the web server 230 during ingress processing of data. The web client 204 communicates with the web server 230. In turn the web server 230 queries the local data store 234 providing results to the web server 230. When the web client 204 approves of the query results, the web client 204 then requests an extraction configuration file 236 corresponding to the query from the web server 230. The web server 230 then generates an extraction configuration file 236 for the web client 204 to download. User at the web client 204 may then use that extraction configuration file 236. The user then executes a separate tool (egress driver 222 and extractors in the configuration data 224) with the extraction configuration file 228. The egress driver 222 runs extractors based on the extraction configuration file 228, to obtain data from the final data store 240.

The general server 202 performs data ingress operations associated with the data and may perform data egress as requested by the web client 204, interactively interfacing with the user, by reading data once the data ingress operations are completed. The general server 202 includes an ingress driver 220, an egress driver 222, configuration data 224, a staging data store 226, and an extraction configuration file 228. The general server 202 retrieves data for ingress from the external data source 208 and stores the data in the starting-point data store 210 for cleaning, sanitizing (e.g., data being stripped of sensitive information), and reformat the data as a part of transforming the data to attain a sufficient level of data integrity for ingress. In aspects, the extraction configuration file 228 may be identical to the extraction configuration file 236 in the data server 206. In some aspects, the extraction configuration file 236 is a temporary file and may be deleted after obtaining data from the final data store 240. Maintaining a copy in respective servers (e.g., the general server 202 and the data server 206) may improve efficiency of generating an answer to a query by looking up a copy locally in respective servers.

In aspects, during data ingress, data is staged as it moves through transformers, itemizers, and/or testers. The ingress driver 220 uses the configuration data 224 to move data from starting point 210 to the staging data store 226 during the transformation and itemization processes. The ingress driver connects to the web server 230 to obtain parameter substitution information and to submit itemization metadata. The web server 230 places the metadata into the database 232 which uses local data store 234 for database storage. In aspects, the starting point 210 and staging data store 226 may be located on or off the general server. In an example, the start-point data store 210 and the staging data store 226 may be collocated in the general server 202. In another example, one or both of the start-point data store 210 and the staging data store 226 may be located and accessible from the general server 202 across a network (e.g., network drives).

In aspects, during data egress, web client 204 makes query request to web server 230 which in turn queries the database container 232 which in turn gathers the query data from local data store 234. The database container 232 returns a subset of data to the web server 230 which in turn returns the subset of data to the web client 204. For efficiency, a subset (as specified by user) of the query response data (with summary information for the full set) may be returned to the web client 204. If the user at the web client 204 likes the response, the query is submitted from the web client 204 to web server 230 to database container 232 the response data from the database container 232 is returned to the web server 230 which generates an extraction configuration file 236 and uploads it to the web client 204. The extraction configuration file 236 may then be removed from the data server 206. The web client 204 executes the egress driver 222 (which may be located on machine that is operated by the user, or in another supported environment) specifying the extraction configuration file 228. The egress driver 222 uses the extraction configuration file 228 to execute extractor programs indicated by the extraction configuration file 228, that then locates data on the final data store 240 and deposits the extracted items into the local machine used by the user.

In aspects, the general server 202 includes at least a part of the data catalog and ingress processor (live) 110B. The general server 202 receives data from an external data source 208 (e.g., the external data store 102 as shown in FIG. 1) through a starting-point data store 210. In aspects, the external data source 208 represents customer contact data, or Amazon, or twitter, or email, or the like. Data may be pulled from the external data source 208 in various formats and deposited to a start-point data store 210. In aspects, the start-point data store 210 may store raw captured, unclean data. After successfully validating data for ingress, the general server 202 stores the data in the staging data store 226 (e.g., the staging data store (live) 152 as shown in FIG. 1). The general server 202 may copy the data to the final data store 240 (i.e., an ingress deposit). In some aspects, the general server 202 may move the data from the starting-point data store 210 directly to the final data store 240 for data ingress. In aspects, the general server 202 determines a data type associated with data for ingress by validating the data in the starting-point data store 210 against a set of known data types. When the data type is unknown, the general server 202 interactively generates new configuration data 224 (e.g., ingress configuration data). A set of configuration data corresponds to a data type of content data, including an ingress script and an egress script. In aspects, the ingress script includes instructions for the ingress of data from the external data source 208 to the final data store 240 through the staging data store 226 and for storing metadata associated with the data in the local data store 234. In aspects, the egress script includes instructions for the egress of data stored in the final data store 240 to the user local environment. The set of configuration data may further include transformer instruction code identifiers, itemizer instruction code identifiers, and tester instruction code identifiers for ingress and ingress validation for data ingress operations. One or more transformers transform data into a predetermined data type. The itemizer identifies various sub items and characteristics (metadata) of the item and sub items of the original data file, sending that information to the user local environment to store the metadata in the local data store 234. The itemizer itemizes at least a part of content of the data for generating metadata. In aspects, the disclosed technology uses the extractor when the user queries and needs results later.

In some aspects, the general server 202 operates at least in three distinct modes of operation: a development mode, a test mode, and a live mode. In the development mode, the general server 202 interactively generates a new configuration data for data ingress of a new data type. In the test mode, the general server 202 validates data ingress by validating results of data ingress for testing, In the live mode, the general server 202 performs data ingress based on a set of configuration data 224 for ingress. The transformer instruction code as specified by the configuration data may retrieve data from the external data source 208 to the starting-point data store 210 continuing through the Staging Data Store 226, preparing content of the data. In aspects, the data ingress includes a transformer that is responsible for preparing data. Once prepared and reformatted data during ingress, the itemizer instruction code as specified by the configuration data itemizes content of the data and identifies metadata and extraction code identifiers associated with the data items, in aspects may further label various items, and stores the metadata and associated extraction code identifiers in the Local Data Store 234, via Metadata transfer 254 REST calls to the Web Server 230, and copies content data into the Final Data Store 240. In some aspects, validation of ingress data uses egress extractor instruction code as specified by the configuration data test instruction code to extract at least a part of content of the data and stores in the staging data store 226 to verify and validate a successful ingress. Upon a successful completion of ingress of the data, test instruction code reports success or failure of ingress.

Upon receiving a query against metadata to identify associated data items, the web server 230 uses the database container 232 and accesses the local data store 234 (the metadata database) to retrieve a subset of the requested data item location information and/or associated data content. When a web client user is satisfied with a request for retrieving items from content of the data, the web client 204 reissues the query, requesting an Extraction Configuration File 236, to the web server 230, which uses the database container 232 and accesses the local data store 234 (the metadata database) to retrieve the data item location information consistent with the query. The web server 230, generates an Extraction Configuration File 236, containing location and extraction instruction code identifiers associated with the desired data set. The web server transmits the Extraction Configuration File 236 to the Web Client 204. In aspects, once the web client receives the Extraction Configuration File 236, it becomes Extraction Configuration File 228. The user executes the egress driver 222, which may be located on the web client computing device or another supported environment for execution, specifying the Extraction Configuration File 228. The egress driver 222 uses the extraction configuration file 228 to execute extractor programs indicated by the extraction configuration file 228, that then locate data in the final data store 240 and deposits the extracted items into the local machine used by the user.

In aspects, a REST interface may be used to request data and receive metadata associated with the data after completion of the ingress operations. In aspects, the disclosed technology may also maintain audio files and associated transcriptions. A user may specify a query that obtains items from a transcription. The user may further specify that the query should also retrieve an audio clip associated with an item from the transcript. The data retrieval operation may use start and end timestamps of the item, (e.g., an utterance), locating the associated audio file, and placing start and end information for the audio file into an extraction configuration file 236. When the user executes the extraction driver with the extraction configuration file from a machine with access to the Final Data Store 240, slices of audio corresponding to the requested transcript items are also retrieved.

In aspects, the general server 202 uses file read/write 252 commands to read from and write data in the final data store 240. In particular, the general server 202 selects an extraction configuration file 228 for retrieving (e.g., egress) data stored in the final data store 240. The extraction configuration file 228 may include location information associated with items to be extracted from files associated with the data. An extraction script may be reusable for regenerating retrieved data sets. In aspects, a user may request the web server 230 to provide an extraction.

The ingress driver 220 includes a set of instruction code for performing ingress of data from the external data source 208 through the starting-point data store 210 to the final data store 240. The egress driver 222 includes a set of instruction code for performing egress of data from the final data store 240. In aspects, the ingress driver 220 (via itemizers) sends metadata to a data server 206 via the web server 230. In some aspects, the ingress driver 220 requests system configuration information from the web server 230.

As will be appreciated, the various methods, devices, applications, features, etc., described with respect to FIG. 2 are not intended to be limited to use of the system 200, rather the system 200 is provided as an exemplary system that may be used by the aspects disclosed herein. Accordingly, additional data structures or configurations may be used to practice the methods and systems herein and/or features and applications described may be excluded without departing from the methods and systems disclosed herein.

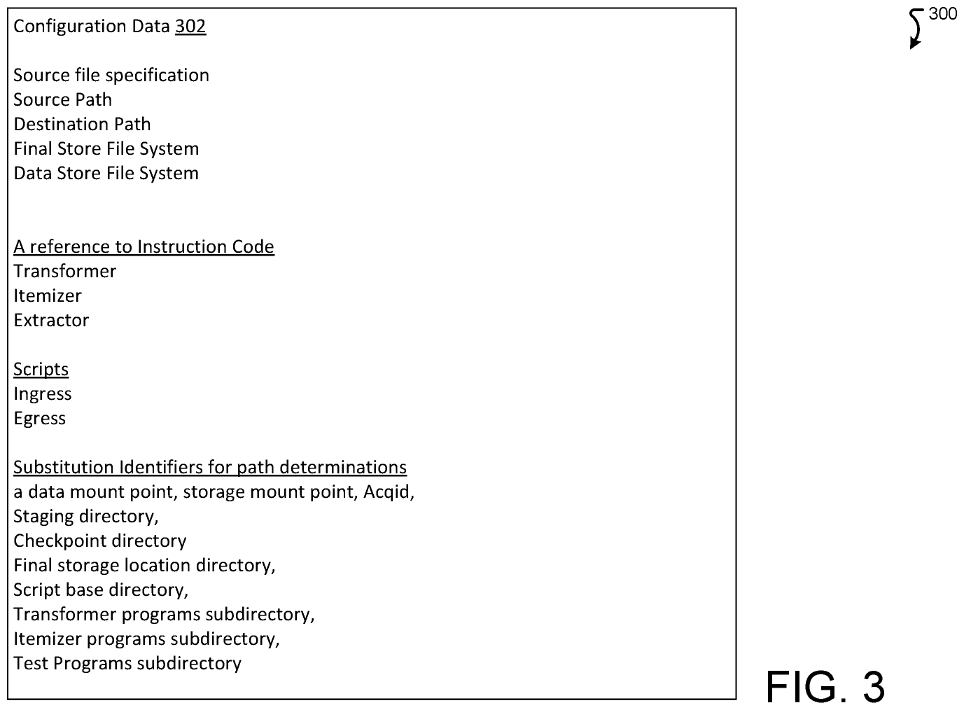

FIG. 3 illustrates an example configuration data 300 in accordance with aspects of the present disclosure. The example configuration data 300 (e.g., the configuration data 224 as shown in FIG. 2) include configuration data 302 indicating source file specification, source path, destination path, final store file system, and data store file system. The source file specification includes wild card file name specification for identifying files within the source path specification to process. The source path indicates a location of files to process. The destination path indicates where to place processed files. The final store file system specifies a file system in which the final data store is located. The data store file system specifies a file system holding ingress data.

In aspects, the configuration data 302 includes references to instruction code that perform the data ingress operation. For example, the references may include a reference to a transformer, a reference to an itemizer of content of data, and a reference to testers to validate ingress of data. In aspects, the configuration data 302 includes scripts associated with data ingress operations. The respective scripts facilitate the respective operations by initiating instruction code for execution using directory paths as specified by the configuration data 302.

The configuration data 302, obtained from the web server 230, may further include path information associated with storing metadata and data in the data catalog and retrieval system. For example, the configuration data 302 may include a data mount point, a storage mount point, an identifier for a data acquisition (“AcqId”), a staging directory, a checkpoint directory, a final storage location directory, a script base directory. The configuration data 302 may further include subdirectory information including a transformer program subdirectory, an itemizer program subdirectory, and a test programs subdirectory.

In aspects, a set of configuration data corresponds to a known data type of data for ingress. A configuration data store (e.g., the configuration data store 134 as shown in FIG. 1) stores the set of configuration data for ingress operations.

As will be appreciated, the various methods, devices, applications, features, etc., described with respect to FIG. 3 is not intended to limit use of the example configuration data 300. Accordingly, additional and/or alternative processes and configurations may be used to practice the methods and systems herein and/or features and applications described may be excluded without departing from the methods and systems disclosed herein.

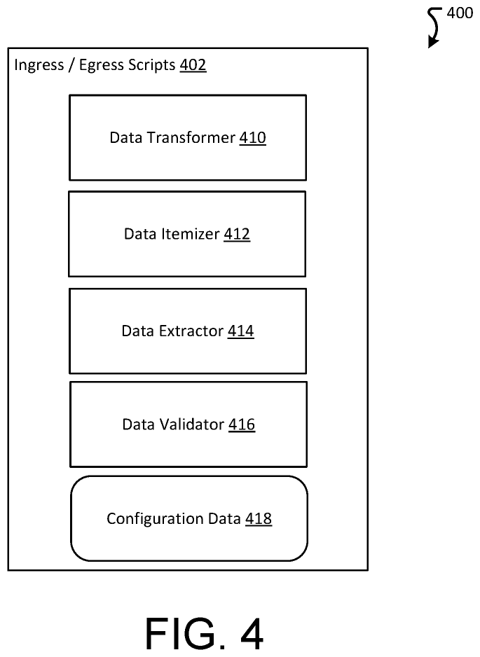

FIG. 4 illustrates an example of ingress/egress scripts in accordance with aspects of the present disclosure. Data schema 400 includes ingress/egress scripts 402 that specify how ingress and egress operations take place. In aspects, the data schema 400 includes a reference to a data transformer 410, a data itemizer 412, a data extractor, a data validator 416, and configuration data 418. In aspects, the data schema 400 is specific to a known data type of data. The data transformer 410 transforms content of data by cleaning, sanitizing (e.g., data being stripped of sensitive information), and reformat data for ingress starting from a starting-point data store (e.g., the starting-point data store 210 as shown in FIG. 2) through the staging data store 226. The data itemizer 412 itemizes content of the data based on a predetermined set of item types for extraction. The data itemizer 412 may further identify and itemize items for inclusion in metadata associated with the data. The data extractor 414 extracts at least a part of content of the data for generating metadata associated with the data. The data extractor 414 is used for egress operations. The data extractors pull data items from the final data store based on the extraction configuration file generated by web client query. The data extractor 414 is used for egress operations. The data extractors pull data items from the final data store based on the extraction configuration file generated by web client query.

In aspects, the data validator 416 tests to ensure that data ingress has expected results. The data validator 416 performs queries of the data after the data ingress operation completes. As part of that validation, the data validator 416 performs an egress operation at least for two reasons: 1) to test that the data ingress operation completed successfully, and 2) to test the extraction types used during the data ingress operation and to validate the egress operation (e.g., that extractors are intact). The egress operation during the validation is to validate that proper egress operations may occur in the future.

As will be appreciated, the various methods, devices, applications, features, etc., described with respect to FIG. 4 are not intended to be limited to use of the data schema 400, rather the data schema 400 is provided as an exemplary system that may be used by the aspects disclosed herein. Accordingly, additional data structures or configurations may be used to practice the methods and systems herein and/or features and applications described may be excluded without departing from the methods and systems disclosed herein.

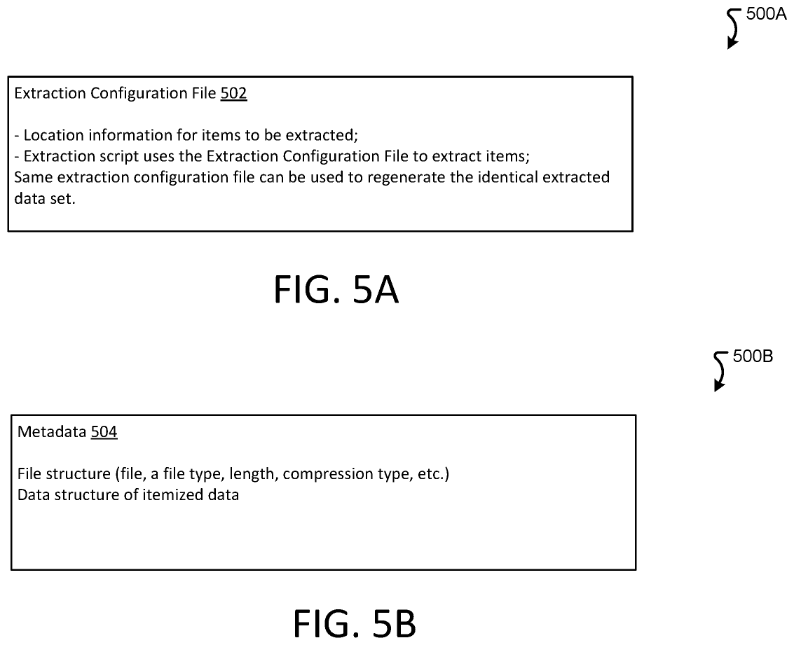

FIGS. 5A-B illustrate examples of an extraction configuration file and metadata in accordance with aspects of the present disclosure. FIG. 5A illustrates an example data structure 500A for an extraction configuration file in accordance with aspects of the present disclosure. The example data structure 500A includes an extraction configuration file 502. In aspects, the extraction configuration file 502 includes location information for items to be extracted based on a query. The extraction configuration file 502 may further indicate an extraction script for extracting items from data stored in a final data storage (e.g., an ingress data deposit). In aspects, an extraction configuration file may be reusable. In aspects, the extraction configuration file 502 may identify scripts to be executed for extracting data. The same extraction configuration file 502 may be used to regenerate identical sets of extracted data.

FIG. 5B illustrates an example of metadata in accordance with aspects of the present disclosure. A data structure 500B includes metadata 504. The metadata 504 includes information that describes a file structure of a file (or data) for retrieval from the final data store. In an example, metadata associated with the file structure may include a file type, length, compression type, and the like. The metadata 504 may further include a data structure of itemized data, which are extracted from the data stored in the final data store. In aspects, a metadata database (e.g., the metadata database 106 as shown FIG. 1 and the local data store 234 as shown in FIG. 2) stores the metadata and uses the metadata in response to receiving queries.

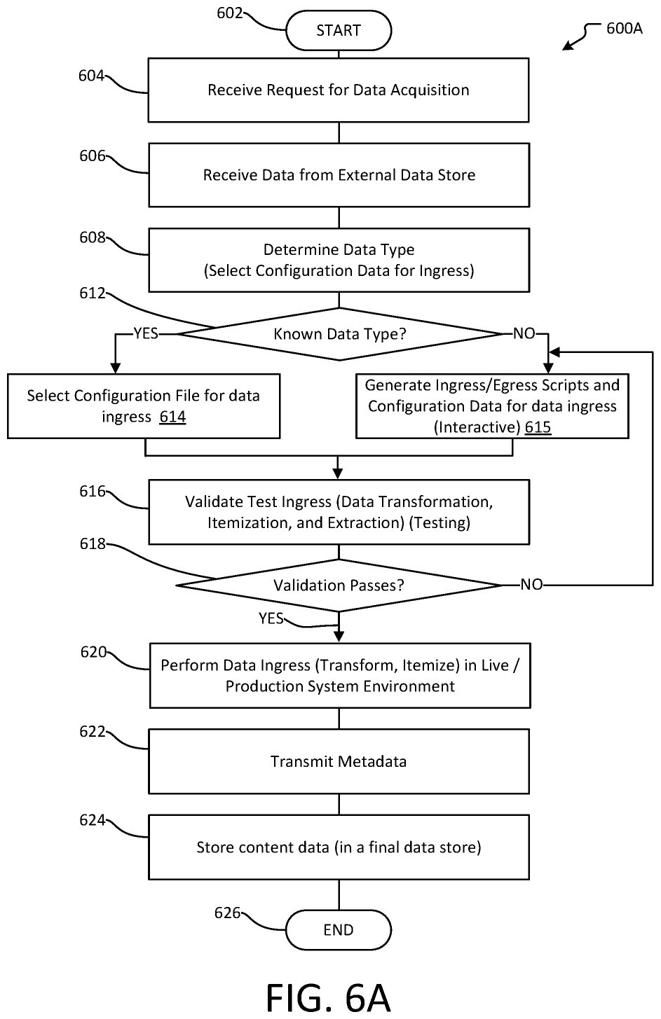

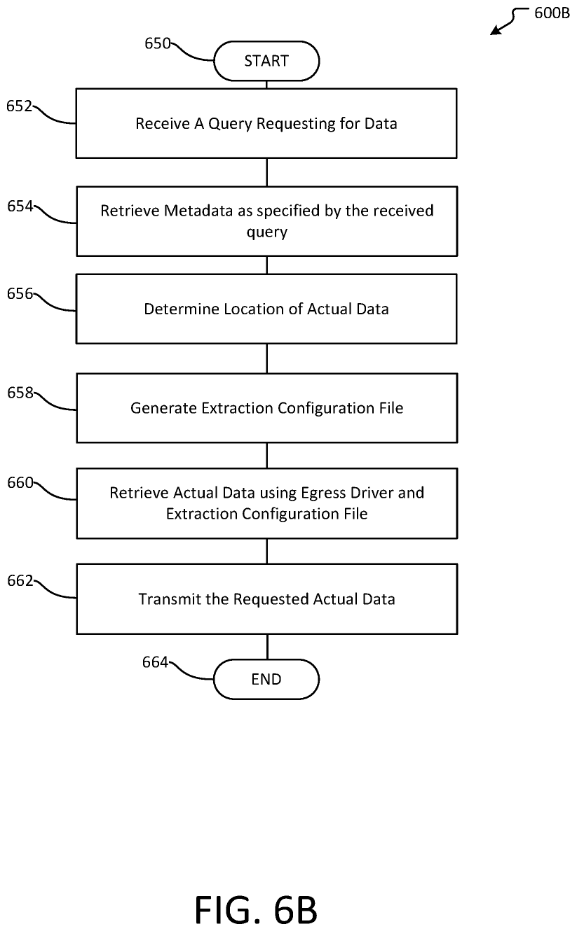

FIG. 6A illustrates an exemplary method 600A associated data ingress in accordance with aspects of the present disclosure. A general order of the operations for the exemplary method 600A is shown in FIG. 6A. Generally, the method 600A begins with start operation 602 and end with end operation 626. The method 600A may include more or fewer steps or may arrange the order of the steps differently than those shown in FIG. 6A. The method 600A can be executed as a set of computer-executable instructions executed by a cloud system and encoded or stored on a computer readable medium. Further, the method 600A can be performed by gates or circuits associated with a processor, an ASIC, an FPGA, a SOC or other hardware device. Hereinafter, the method 600A shall be explained with reference to the systems, components, devices, modules, software, data structures, data characteristic representations, signaling diagrams, methods, etc., described in conjunction with FIGS. 1, 2, 3, 4, 5A-B, 6B, and 7.

Following start operation 602, the method 600A begins with receive operation 604, which receives a request for data acquisition into a data catalog and retrieval system. In aspects, the receive operation 604 receives a request for data acquisition from a data server (e.g., the data server 206 as shown in FIG. 2). The data acquisition may include accessing an external data store (e.g., the external data source 208 as shown in FIG. 1) and performing data ingress and validating the data.

A receive data operation 606 receives data from the external data store. In aspects, the data may include audio and/or video data (e.g., data associated with an incoming telephone call to a customer support center). The data may further include transcript data of the call. Additionally, or alternatively, the data may include content and information associated with postings on social media and other communication systems. In aspects, the receive data operation 606 reads the data as specified by the request for data acquisition and stores the data in a staging data store (e.g., the staging data store 130 as shown in FIG. 1 or a starting-point data store 210).

A determine data type operation 608 determines a data type of the data. Examples of data types may include a data type of audio/video data and/or a data format associated with transcript data. In aspects, the disclosed technology may select a set of configuration data associated with a known data type for data ingress when the determine data type operation 608 determines a data type that is known to the system.

A known data type decision operation 612 decides whether a data type used in the data is always known to the system. When a data type is known (Known data type=“YES”), the operation proceeds to a select operation 614 that selects a configuration file for the data ingress.

When the system decides that the data type is unknown, the system lacks configuration data associated with the data type. When a data type is unknown (Known data type=“NO”), the operation proceeds to a generate operation 615 that generates ingress/egress scripts and configuration data for the data type as a new data type to be supported by the system.

The generate operation 615 interactively generates scripts associated with ingress and egress operations and configuration data for ingress. In aspects, the generate operation 615 may receive a set of identifiers for instruction code for transforming, and itemizing.

A validate operation 616 performs data ingress operations based on the selected/generated scripts for ingress and the configuration. In aspects, the validate operation 616 may interactively confirm correct data. The validate operation 616 may use a test Metadata Database (Test) 106A, test Staging Data store 132, test Data Store 136 as shown in FIG. 1.

A decision operation 618 decides whether the validate operation 616 successfully validated data. When the validation did not successfully pass, the operation proceeds to regenerating ingress scripts, egress scripts, and configuration data for data ingress.

A perform operation 620 performs the data ingress operation based on the validated ingress scripts and configuration files in the live/production system environment. In aspects, the perform operation 620 transforms and itemizes the received data types. In an example, a data catalog and ingress processor (e.g., the data catalog and ingress processor (live) 110B as shown in FIG. 1) performs the perform data ingress operation 620.

A transmit metadata 622 transmits metadata extracted from the data that has completed the data ingress operations to the metadata database (live) over the network.

A store operation 624 stores content data in the final data store (e.g., the data store live 156 as shown in FIG. 1). In aspects, the data store live 156 stores the acquired actual data.

The end operation 626 ends the method 600A.

As should be appreciated, operations 602-626 are described for purposes of illustrating the present methods and systems and are not intended to limit the disclosure to a particular sequence of steps, e.g., steps may be performed in different order, additional steps may be performed, and disclosed steps may be excluded without departing from the present disclosure.

FIG. 6B illustrates an example method 600B for data egress in accordance with aspects of the present disclosure. A general order of the operations for the method 600B is shown in FIG. 6B. Generally, the method 600B begins with start operation 650 and end with end operation 664. The method 600B may include more or fewer steps or may arrange the order of the steps differently than those shown in FIG. 6B. The method 600B can be executed as a set of computer-executable instructions executed by a cloud system and encoded or stored on a computer readable medium. Further, the method 600B can be performed by gates or circuits associated with a processor, an ASIC, an FPGA, a SOC or other hardware device. Hereinafter, the method 600B shall be explained with reference to the systems, components, devices, modules, software, data structures, data characteristic representations, signaling diagrams, methods, etc., described in conjunction with FIGS. 1, 2, 3, 4, 5A-B, 6A and 7.

Following start operation 650, the method 600B begins with receive operation 652, which receives a request for metadata and/or data in a data catalog and retrieval system. An example of the request may include a query that requests for audio data and transcripts corresponding to the first twenty seconds of the most recent fifty contacts that a particular operator participated. Another example of the request may include a query for retrieving information and/or content associated with recent postings by particular users on a social media system.

A retrieve metadata operation 654 retrieves metadata associated with data as specified by the received query. In aspects, the retrieve metadata operation 654 retrieves the metadata from the local data store 234 (metadata; e.g., the metadata database (live) 106B as shown in FIG. 1). In aspects, the metadata indicates locations of data items to be extracted from the data in a final data store (e.g., the data store live 156 as shown in FIG. 1 and the final data store 240 as shown in FIG. 2).

A determine operation 656 determines and retrieves the locations of actual data based on the retrieved metadata.

A generate operation 658 generates an extraction configuration file associated with data as specified by the received query. The generate operation 658 further selects the appropriate extraction script and generates the extraction configuration file based on the received query. In aspects, the generate operation 658 further selects the extraction script and the extraction configuration file based on a type of data that corresponds to the requested data. Additionally, or alternatively, the generate operation 658 may select the extraction script and the extraction configuration file based on an interactive selection received through a graphical user interface.

A retrieve actual data operation 660 retrieves actual data associated with the requested data. In aspects, the extraction configuration file may specify an egress extraction script that performs egress (extraction) operation of data stored in the final data store.

A transmit operation 662 transmits and deposits data as requested by the egress driver and extraction configuration file. The transmitted data includes reply data to the received query that requested the data. The method 600B ends with the end operation 664.

As should be appreciated, operations 650-664 are described for purposes of illustrating the present methods and systems and are not intended to limit the disclosure to a particular sequence of steps, e.g., steps may be performed in different order, additional steps may be performed, and disclosed steps may be excluded without departing from the present disclosure.

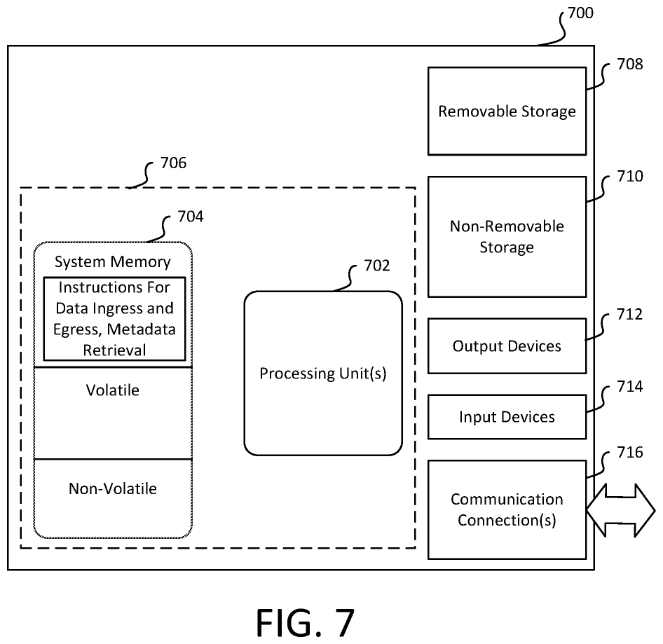

FIG. 7 illustrates a simplified block diagram of a device with which aspects of the present disclosure may be practiced in accordance with aspects of the present disclosure. The device may be a mobile computing device, for example. One or more of the present embodiments may be implemented in an operating environment 700. This is only one example of a suitable operating environment and is not intended to suggest any limitation as to the scope of use or functionality. Other well-known computing systems, environments, and/or configurations that may be suitable for use include, but are not limited to, personal computers, server computers, hand-held or laptop devices, multiprocessor systems, microprocessor-based systems, programmable consumer electronics such as smartphones, network PCs, minicomputers, mainframe computers, distributed computing environments that include any of the above systems or devices, and the like.

In its most basic configuration, the operating environment 700 typically includes at least one processing unit 702 and memory 704. Depending on the exact configuration and type of computing device, memory 704 (e.g., Instructions for Data Ingress and Egress, Metadata Retrieval as disclosed herein) may be volatile (such as RAM), non-volatile (such as ROM, flash memory, etc.), or some combination of the two. This most basic configuration is illustrated in FIG. 7 by dashed line 706. Further, the operating environment 700 may also include storage devices (removable, 708, and/or non-removable, 710) including, but not limited to, magnetic or optical disks or tape. Similarly, the operating environment 700 may also have input device(s) 714 such as remote controller, keyboard, mouse, pen, voice input, on-board sensors, etc. and/or output device(s) 712 such as a display, speakers, printer, motors, etc. Also included in the environment may be one or more communication connections 716, such as LAN, WAN, a near-field communications network, a cellular broadband network, point to point, etc.

Operating environment 700 typically includes at least some form of computer readable media. Computer readable media can be any available media that can be accessed by the at least one processing unit 702 or other devices comprising the operating environment. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other tangible, non-transitory medium which can be used to store the desired information. Computer storage media does not include communication media. Computer storage media does not include a carrier wave or other propagated or modulated data signal.

Communication media embodies computer readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media.

The operating environment 700 may be a single computer operating in a networked environment using logical connections to one or more remote computers. The remote computer may be a personal computer, a server, a router, a network PC, a peer device or other common network node, and typically includes many or all of the elements described above as well as others not so mentioned. The logical connections may include any method supported by available communications media. Such networking environments are commonplace in offices, enterprise-wide computer networks, intranets and the Internet.

The description and illustration of one or more aspects provided in this application are not intended to limit or restrict the scope of the disclosure as claimed in any way. The claimed disclosure should not be construed as being limited to any aspect, for example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

The present disclosure relates to systems and methods for cataloging and retrieving data. Any of the one or more above aspects in combination with any other of the one or more aspect. Any of the one or more aspects as described herein.

1. A computer-implemented method, comprising:
receiving data from a remote data storage;
selecting configuration data associated with a data type of the data;
validating the data using the selected configuration data;
transforming the data;
itemizing the data;
extracting the data;
generating metadata associated with the itemized data; and
storing the metadata and the itemized data.

2. The method of claim 1, further comprising:
identifying the data type of the data;
when the data type is unidentifiable, generating the configuration data associated with the data type; and
validating ingress of the data using the generated configuration data using a test environment.

3. The method of claim 1, further comprising:
when the validating the data fails, regenerating the configuration data associated with the data type; and
validating ingress of the data using the generated configuration data using a test environment.

4. The method of claim 1, wherein the configuration data include:
a first identifier of a first instruction code configured to transform the data type of the data into a predefined data type,
a second identifier of a second instruction code configured to itemize parts of the data, and
a third identifier of a third instruction code configured to extract the parts of the data.

5. The method of claim 1, wherein the configuration data include:
a first location of a staging directory; and
a second location of a final data storage for data ingress.

6. The method of claim 1, further comprising:
receiving a query;
determining an extraction configuration data;
retrieving, based the extraction configuration data, the metadata, wherein the metadata specifies at least a part of the extracted data;
retrieving, based on the metadata, response data; and
transmitting the response data.

7. The method of claim 6, wherein the metadata includes a reference to the at least a part of the extracted data.

8. A system, the system comprising:
a processor; and
a memory storing computer-executable instructions that when executed by the processor cause the system to execute a method comprising:
receiving data from a remote data storage;
selecting configuration data associated with a data type of the data;
validating the data using the selected configuration data;
transforming the data;
itemizing the data;
extracting the data;
generating metadata associated with the itemized data; and
storing the metadata and the itemized data.

9. The system of claim 8, the computer-executable instructions when executed further causing the system to execute a method comprising:
identifying the data type of the data;
when the data type is unidentifiable, generating the configuration data associated with the data type; and
validating ingress of the data using the generated configuration data using a test environment.

10. The system of claim 8, the computer-executable instructions when executed further causing the system to execute a method comprising:
when the validating the data fails, regenerating the configuration data associated with the data type; and
validating ingress of the data using the generated configuration data using a test environment.

11. The system of claim 8, wherein the configuration data include:
a first identifier of a first instruction code configured to transform the data type of the data into a predefined data type,
a second identifier of a second instruction code configured to itemize parts of the data, and
a third identifier of a third instruction code configured to extract the parts of the data.

12. The system of claim 8, wherein the configuration data include:
a first location of a staging directory; and
a second location of a final data storage for data ingress.

13. The system of claim 8, the computer-executable instructions when executed further causing the system to execute a method comprising:
receiving a query;
determining an extraction configuration data;
retrieving, based the extraction configuration data, the metadata, wherein the metadata specifies at least a part of the extracted data;
retrieving, based on the metadata, response data; and
transmitting the response data.

14. The system of claim 13, the computer-executable instructions when executed further causing the system to execute a method comprising:
retrieving, based on the metadata, the at least a part of the extracted data as the response data, wherein the metadata includes a reference to the part of the extracted data.

15. The computer-readable storage medium storing computer-executable instructions that when executed by a processor cause a system to execute a method comprising:
receiving data from a remote data storage;
selecting configuration data associated with a data type of the data;
validating the data using the selected configuration data;
transforming the data;
itemizing the data;
extracting the data;
generating metadata associated with the itemized data; and
storing the metadata and the itemized data.

16. The computer-readable storage medium of claim 15, the computer-executable instructions when executed further causing the system to execute a method comprising:
identifying the data type of the data;
when the data type is unidentifiable, generating the configuration data associated with the data type; and
validating ingress of the data using the generated configuration data using a test environment.

17. The computer-readable storage medium of claim 15, the computer-executable instructions when executed further causing the system to execute a method comprising:
when the validating the data fails, regenerating the configuration data associated with the data type; and
validating ingress of the data using the generated configuration data using a test environment.

18. The computer-readable storage medium of claim 15, wherein the configuration data include:
a first identifier of a first instruction code configured to transform the data type of the data into a predefined data type,
a second identifier of a second instruction code configured to itemize parts of the data, and
a third identifier of a third instruction code configured to extract the parts of the data.

19. The computer-readable storage medium of claim 15, wherein the configuration data include:
a first location of a staging directory; and
a second location of a final data storage for data ingress.

20. The computer-readable storage medium of claim 15, the computer-executable instructions when executed further causing the system to execute a method comprising:
receiving a query;
determining an extraction configuration data;
retrieving, based the extraction configuration data, the metadata, wherein the metadata specifies at least a part of the extracted data;
retrieving, based on the metadata, response data; and
transmitting the response data.
